(19) United States
(12) Patent Application Publication
(10) Pub. No.: US 2026/0211102 A1
(43) Pub. Date: Jul. 23, 2026

(54) FREQUENCY CONVERSION DEVICE, RADAR DEVICE, FREQUENCY CONVERSION METHOD AND FREQUENCY CONVERSION PROGRAM

(71) Applicant: Furuno Electric Co., Ltd., Nishinomiya (JP)

(72) Inventors: Tomoki NAGAYA, Akashi (JP); Hironori TAKAHASHI, Nishinomiya (JP); Tomonao KOBAYASHI, Kawanishi (JP); Akihiro HINO, Kakogawa (JP)

(21) Appl. No.: 19/444,527

(22) Filed: Jan. 9, 2026

Related U.S. Application Data
(63) Continuation of application No. PCT/JP2024/026431, filed on Jul. 24, 2024.

(30) Foreign Application Priority Data
Jul. 26, 2023 (JP) 2023-121203

(51) Int. Cl. G01S 13/58; G01S 7/03; G01S 7/292; G01S 7/32

(52) U.S. Cl. CPC G01S 13/589; G01S 7/03; G01S 7/292; G01S 7/32

(57) ABSTRACT

To detect speed and movement direction of a detection object in a simple configuration in a radar device, a frequency conversion device is disclosed. The frequency conversion device includes a digital-to-analog converter for generating an analog signal; an up-converter for generating an RF (radio frequency) signal by multiplying the analog signal with a first local signal; a transmitter for transmitting the RF signal; a receiver for receiving a reflected signal of the RF signal; a down-converter for generating an IF (intermediate frequency) signal by multiplying the reflected signal with a second local signal; an analog-to-digital converter for generating a digital signal by digitally converting the IF signal; and processing circuitry for generating a baseband signal having a cancelled phase rotation component based on the frequency difference between the first local signal and the second local signal.

### TECHNICAL FIELD

The present invention relates to a frequency conversion device, radar device, frequency conversion method, and frequency conversion program.

### BACKGROUND ART

Conventionally, in communication devices, radar devices and the like, a technique configured to generate a baseband signal that is used for down-converting an RF (radio frequency) signal received via an antenna using a local signal.

For example, Patent Literature 1 (Japanese Unexamined Patent Application Publication No. 2009-272830) describes a communication device as follows. The communication device includes an RF transmission/reception processing means for performing RF processing of transmission/reception signals, a baseband processing means for performing baseband processing, a signal detection means for detecting a signal for detecting a transmission signal from another communication system, and an interference avoidance means for suppressing an interference signal to the other communication system in RF transmission processing of the RF transmission/reception processing means when the signal is detected by the interference signal detection means.

### CITATION LIST

### Patent Literature

PTL 1: Patent Literature 1: Japanese Unexamined Patent Application Publication No. 2009-272830

PTL 2: Patent Literature 2: Japanese Unexamined Patent Application Publication (Translation of PCT Application) No. 2019-512195

### SUMMARY OF INVENTION

### Technical Problem

Beyond the technologies described in Patent Literatures 1 and 2, it is desirable to have a technology capable of detecting the speed and movement direction of an object to be detected in a radar device in a simple configuration.

The present invention is made to solve the above-mentioned problems. An object of the present invention is to provide a frequency conversion device, a radar device, a frequency conversion method, and a frequency conversion program capable of detecting the speed and movement direction of the object to be detected in the radar device in the simple configuration.

### Solution to Problem

(1) In order to solve the above-mentioned problems, a frequency conversion device, according to a first aspect of the present invention, comprises a digital-to-analog converter that generates an analog signal by analog conversion of data representing a pulse-like waveform; an up-converter that generates an RF signal by multiplying the analog signal with a first local signal; a transmitter that transmits the RF signal; a receiver that receives a reflected signal of the RF signal; a down-converter that generates an IF (intermediate frequency) signal by multiplying the reflected signal with a second local signal having a different frequency from the first local signal; and an analog-to-digital converter that generates a digital signal by digitally converting the IF signal. Thereafter, the system includes processing circuitry configured to generate a baseband signal having a cancelled phase rotation component based on a frequency difference between the first local signal and the second local signal.

Thus, in the frequency conversion device having a frequency of the first local signal used for up-conversion of the transmitted signal and a frequency of the second local signal used for down-conversion of the received reflected signal being different from each other, the baseband signal having the cancelled phase rotation component based on the frequency difference between the first local signal and the second local signal is generated, the speed and movement direction of the object at the reflection point of the RF signal may be detected based on the cancelled phase rotation component corresponding to the propagation delay time of the RF signal included in the generated baseband signal, while a circuit scale is downsized as compared with a double super heterodyne system. Therefore, in the radar device, the speed and the movement direction of the detection object may be detected in a simple configuration.

(2) In (1) above, the processing circuitry may generate the baseband signal by multiplying the digital signal with a third local signal of a frequency based on the frequency difference, and the third local signal may be a free-run signal.

With such configuration, it is possible to generate the baseband signal having the cancelled phase rotation component based on the frequency difference between the first local signal and the second local signal without requiring any arithmetic process.

(3) In (1) above, the processing circuitry may generate the baseband signal by subtracting component of the phase rotation calculated based on the frequency difference and the transmission period of the RF signal from the signal obtained by multiplying the digital signal and the third local signal of the frequency based on the frequency difference.

With such configuration, for example, using the third local signal having an initial phase in the transmission timing of the RF signal being zero, it is possible to generate the baseband signal having the cancelled phase rotation component based on the frequency difference between the first local signal and the second local signal while suppressing the generation of unnecessary component caused by the up-conversion of the transmitted signal and the down-conversion of the received signal.

(4) In order to solve the above-mentioned problems, the radar device, according to this aspect of the present invention, is provided with any of the frequency conversion devices (1) to (3) above.

With such a configuration, for example, the radar device may notify a user of the speed and movement direction of the detected object.

(5) In order to solve the above-mentioned problems, a frequency conversion method, according to a certain aspect of the present invention, is disclosed. In the frequency conversion method of a frequency conversion device, an analog signal is generated by analog conversion of data representing a pulse-like waveform, an RF signal is generated by multiplying the analog signal with a first local signal, the RF signal is transmitted, a reflected signal of the RF signal is received, an IF signal is generated by multiplying the reflected signal with a second local signal having a frequency different from the first local signal, a digital signal is generated by digital conversion of the IF signal, and a baseband signal having a cancelled phase rotation component based on a frequency difference between the first local signal and the second local signal that is generated based on the digital signal.

Thus, in the frequency conversion device in which the frequency of the first local signal used for up-conversion of the transmitted signal and the frequency of the second local signal used for down-conversion of the received reflected signal are different from each other, by a method of generating a baseband signal having a cancelled phase rotation component based on the frequency difference between the first local signal and the second local signal, the speed and movement direction of an object at the reflection point of the RF signal may be detected based on the component of the phase rotation corresponding to the propagation delay time of the RF signal included in the baseband signal while reducing the circuit scale as compared with the double super heterodyne method. Therefore, in the radar device, the speed and the moving direction of the object may be detected with the simple configuration.

(6) In order to solve the above-mentioned problems, a frequency conversion program, according to an aspect of the present invention, is used in a frequency conversion device that generates an analog signal by analog-converting data representing a pulse-like waveform, generates an RF signal by multiplying the analog signal with a first local signal, transmits the RF signal, receives a reflected signal of the RF signal, generates an IF signal by multiplying the reflected signal with a second local signal having a different frequency from the first local signal, and generates a digital signal by digitally converting the IF signal, and causes a computer to execute a process of generating a baseband signal having a cancelled component of phase rotation based on a frequency difference between the first local signal and the second local signal based on the digital signal.

Thus, in the frequency conversion device in which the frequency of the first local signal used for up-conversion of the transmitted signal and the frequency of the second local signal used for down-conversion of the received reflected signal are different from each other, by the configuration of generating a baseband signal in which the component of the phase rotation based on the frequency difference between the first local signal and the second local signal is cancelled, the speed and the moving direction of the object at the reflection point of the RF signal may be detected based on the component of the phase rotation corresponding to the propagation delay time of the RF signal included in the baseband signal while reducing the circuit scale as compared with the double super heterodyne system. Therefore, in the radar device, the speed and the moving direction of the object may be detected with the simple configuration.

### Advantageous Effects of the Invention

According to the present invention, the speed and movement direction of the object to be detected may be detected with a simple configuration in the radar device.

### BRIEF DESCRIPTION OF DRAWINGS

FIG. 1 is a diagram showing a configuration of a radar device according to a first embodiment of the present invention.

FIG. 2 is a diagram showing a configuration of the radar device according to a conventional double superheterodyne system.

FIG. 3 is a diagram showing a timing chart of local signals used in the radar device according to the conventional double superheterodyne system.

FIG. 4 is a diagram showing the timing chart of the local signal used in a frequency conversion device according to a first embodiment of the present invention.

FIG. 5 is a flowchart showing an example of an operation when the radar device performs detection process according to the first embodiment of the present invention.

FIG. 6 is a diagram showing a configuration of the radar device according to a second embodiment of the present invention.

FIG. 7 is a diagram showing the timing chart of the local signal used in the frequency conversion device according to the second embodiment of the present invention.

FIG. 8 is a flowchart showing an example of an operation when the radar device performs detection process according to the second embodiment of the present invention.

### DESCRIPTION OF EMBODIMENTS

Embodiments of the present invention will now be described with reference to the drawings. The same reference numerals are used for the same or equivalent portions in the drawings, and the description is not repeated. In addition, at least a part of the following embodiments may be optionally combined.

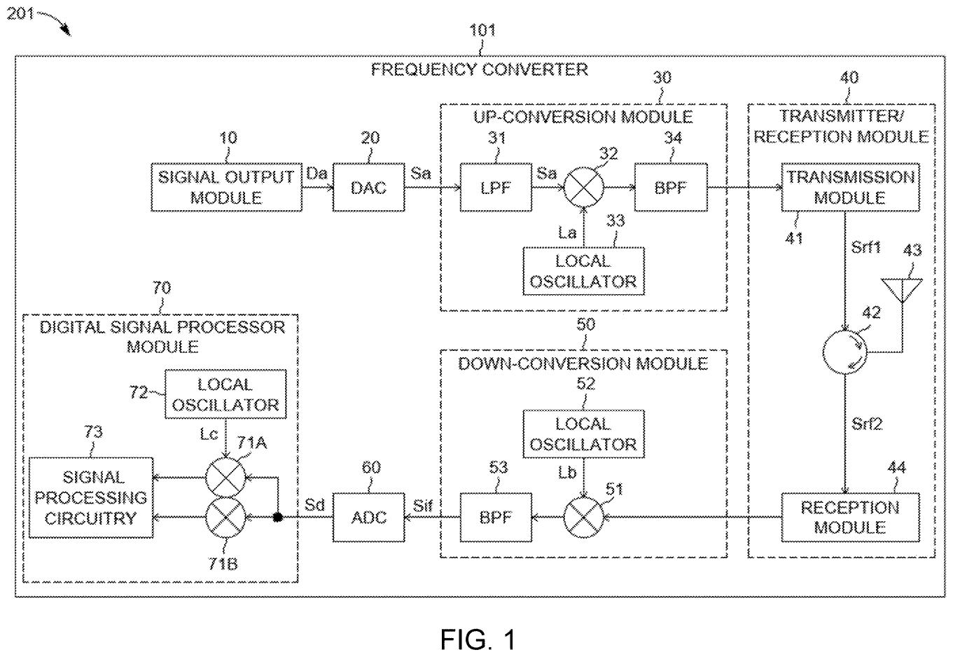

FIG. 1 is a diagram showing a configuration of a radar device, according to a first embodiment of the present invention. Referring to FIG. 1, the radar device (201) includes a frequency converter (101). The frequency converter (101) includes a signal output module (10), a digital-to-analog converter (DAC) (20), an up-conversion module (30) (which is also referred to as up-converter), a transmitter/reception module (40), a down-conversion module (50) (which is also referred to as down-converter), an analog-to-digital converter (ADC) (60), and a digital signal processor module (70). The radar device (201) is a radar according to a direct conversion system and a solidification radar using a solidification element. In one example, the radar device (201) is mounted on a ship.

The radar device (201) performs detection process for detecting the presence or absence of a target in a detection target area which is a region to be monitored and the distance between the radar device (201) and the target. The target is an example of an object to be detected. More specifically, in the detection process, the radar device (201) transmits an RF signal (Srf1), which is a transmission wave, to the area to be detected at a transmission timing (Tt) following a predetermined transmission period (Tprf). In one example, the transmission period (Tprf) is, for example, 1 millisecond. The radar device (201) receives a RF signal (Srf2) which is a reflected signal of the RF signal (Srf1) in the detection target area. Based on the received RF signal (Srf2), the radar device (201) performs processing to display an echo image indicating the presence or absence of the target in the detection target area and the distance between the radar device (201) and the target on a display device (not shown). In the following, the propagation delay time of the signal in the radar device (201) is smaller than the propagation delay time of the RF signal in the detection target area and may be ignored.

The up-conversion module (30) includes an LPF (Low Pass Filter) (31), a mixer (32), a local oscillator (33), and a BPF (Band Pass Filter) (34). The local oscillator (33) outputs a local signal (La) of a frequency (fa) of the RF band to the mixer (32). The local signal (La) is an example of a first local signal.

The transmitter/reception module (40) includes a transmission module (41) (which is also referred to as transmitter), a circulator (42), an antenna (43), and a reception module (44) (which is also referred to as receiver).

The down-conversion module (50) includes a mixer (51), a local oscillator (52), and a BPF (53). The local oscillator (52) outputs a local signal (Lb) of a frequency (fb) of the RF band to the mixer (51). The local signal (Lb) has a different frequency from the local signal (La). For example, the frequency (fb) of the local signal (Lb) is several tens of megahertz lower than the frequency (fa) of the local signal (La). The local signal (Lb) is an example of a second local signal.

The frequency (fb) of the local signal (Lb) may be several tens of megahertz higher than the frequency (fa) of the local signal (La). However, by setting the frequency (fb) to the frequency lower than the frequency (fa), it may be possible to use the ADC (60) (which is also referred to as having a lower sampling frequency than when the frequency (fb) is set to the frequency higher than the frequency (fa).

The digital signal processor (70) includes mixers (71 A) and (71B) which are mixers (71), a local oscillator (72), and a signal processing circuitry (73). The digital signal processor (70) is an example of a cancellation module. The local oscillator (72) outputs a local signal (Lc) of a frequency (fc) to the mixer (71). The local signal (Lc) is the frequency signal based on the frequency difference between the local signal (La) and the local signal (Lb). In one example, the frequency (fc) of the local signal (Lc) is the frequency corresponding to the difference between the frequency (fa) and the frequency (fb). The local signal (Lc) is an example of a third local signal.

In the following, for the sake of simplicity, the initial phases of the local signals (La), (Lb), and (Lc) at the start of the radar device (201) are assumed to be 0. The local signal (La) at time (t) is represented by the following equation (1). Here, ωa is an angular frequency of the local signal (La).

$$\begin{matrix}MATH 01 & \\ La = cos ( ω a \times t ) & ( 1 )\end{matrix}$$

The local signal (Lb) at time t is represented by the following equation (2). Here, ωb is the angular frequency of the local signal (Lb).

$$\begin{matrix}MATH 02 & \\ Lb = cos ( ω b \times t ) & ( 2 )\end{matrix}$$

Further, the local signal (Lc) at time (t) is represented by the following equation (3). Here, ωc is the angular frequency of the local signal (Lc).

$$\begin{matrix}MATH 03 & \\ Lc = cos ( ω c \times t ) & ( 3 )\end{matrix}$$

The signal output module (10) outputs data (Da) representing a pulse-shaped waveform to the DAC (20). For example, the signal output module (10) outputs data (Da) representing a pulse signal that transitions from a low level to a high level at the transmission timing (Tt) and transitions from the high level to the low level after a predetermined time (T1) from the transmission timing (Tt) to the DAC (20). The predetermined time (T1) may be shorter than the transmission period (Tprf), for example, 150 microseconds.

The DAC (20) generates an analog signal (Sa) by an analog conversion of the data (Da) representing the pulse waveform. More specifically, the DAC (20) generates an analog pulse signal by an analog conversion of the data (Da) received from the signal output module (10), and outputs the generated analog signal (Sa) to the up-conversion module (30).

The up-conversion module (30) multiplies the analog signal (Sa) and the local signal (La) to generate the RF signal (Srf1). More specifically, the LPF (31) in the up conversion module (30) attenuates component outside a predetermined passband among the frequency component of the analog signal received from the DAC (20). The mixer (32) generates the RF signal (Srf1) by multiplying the analog signal (Sa) passed through the LPF (31) with the local signal (La) received from the local oscillator (33) and outputs it to the BPF (34). The BPF (34) attenuates the frequency component of the RF signal (Srf1) received from the mixer (32) outside the predetermined passband.

The transmission module (41) in the transmitter/reception module (40) transmits the RF signal (Srf1). More specifically, the transmission module (41) transmits the RF signal (Srf1) that may be passed through the BPF (34) to the area to be detected via the circulator (42) and the antenna (43).

The reception module (44) in the transmitter/reception module (40) receives the RF signal (Srf2), which is the reflected signal to which the RF signal (Srf1) is reflected. More specifically, the reception module (44) receives the RF signal (Srf2) which is the signal to which the RF signal (Srf1) is reflected by the object or the like in the detection target area, via the antenna (43) and the circulator (42), and outputs the received RF signal (Srf2) to the down-conversion module (50).

Hereinafter, each of the RF signals (Srf1) and (Srf2) is also referred to as a RF signal (Srf). The RF signal (Srf) at time (t) transmitted and received by the transmitter/reception module (40) is represented by the following equation (4), considering the phase of the local signal (La) at the transmission timing (Tt).

$$\begin{matrix}MATH 04 & \\ Srf = cos ( ω a \times t + ω a \times Tt ) & ( 4 )\end{matrix}$$

Further, the reception timing (Tr) of the RF signal (Srf2) in the reception module (44) is represented by the following equation (5).

$$\begin{matrix}MATH 05 & \\ Tr = Tt + \frac{2 R}{c} & ( 5 )\end{matrix}$$

Here, R is the distance between the reflection point of the RF signal (Srf) and the antenna (43). Further, c is the speed of light (m/s). Further, 2×R/c is the propagation delay time of the RF signal (Srf) in the area to be detected.

The down-conversion module (50) generates an IF signal (Sif) by multiplying the RF signal (Srf2) and the local signal (Lb). More specifically, the mixer (51) in the downconversion module (50) generates the IF signal (Sif) by multiplying the RF signal (Srf2) received from the reception module (44) and the local signal (Lb) received from the local oscillator (52) and outputs it to the BPF (53). The BPF (53) attenuates component outside the predetermined passband among the frequency component of the IF signal (Sif) received from the mixer (51). In one example, the BPF (53) attenuates the frequency component other than the frequency component of the difference between the frequency of the RF signal (Srf2) and the frequency (fb) of the local signal (Lb) among the frequency component of the IF signal (Sif) received from the mixer (51). The IF signal (Sif) passed through the BPF (53) as considering the phase of the local signal (Lb) at the reception timing (Tr) is represented by the following equation (6).

$$\begin{matrix}MATH 06 & \\ Sif = cos \{ ( ω a - ω b ) t + ( ω a - ω b ) Tt - ω b \times \frac{2 R}{c} \} & ( 6 )\end{matrix}$$

The ADC (60) generates a digital signal (Sd) by digitally converting the IF signal (Sif). More specifically, the ADC (60) generates the digital signal (Sd) by digitally converting the IF signal (Sif) received from the down conversion module (50), and outputs the generated digital signal (Sd) to the digital signal processor (70).

The digital signal processor (70) multiplies the digital signal (Sd) and the local signal (Lc). More specifically, the mixer (71 A) in the digital signal processor (70) multiplies the digital signal (Sd) received from the ADC (60) and the local signal (Lc) received from the local oscillator (72), thereby generating a digital signal (SdI) in the baseband band and outputting it to the signal processing circuitry (73). Further, the mixer (71B) in the digital signal processor (70) multiplies the digital signal (Sd) received from the ADC (60) and the local signal Lc_90, which is the local signal (Lc) emitted from the local oscillator (72) and given a phase difference of 90° by a phase shifter (not shown), thereby generating a digital signal (SdQ) in the baseband and outputting it to the signal processing circuitry (73).

The signal processing circuitry (73) receives the digital signal (SdI) from the mixer (71A) and extracts the frequency component of the difference between the frequency of the IF signal (Sif) and the frequency (fc) of the local signal (Lc) among the frequency component of the received digital signal (SdI) as a demodulation signal SI. The signal processing circuitry (73) receives the digital signal (SdQ) from the mixer (71B) and extracts the frequency component of the difference between the frequency of the IF signal (Sif) and the frequency (fc) among the frequency component of the received digital signal (SdQ) as a demodulation signal (SQ). Based on the baseband signals (SBB) represented by the extracted demodulation signals (SI) and (SQ), the signal processing circuitry (73) calculates the presence or absence of the target in the detection target area and the distance between the radar device (201) and the target. The signal processing circuitry (73) then processes to display the echo image indicating the presence or absence of the target in the detection target area and the distance between the radar device (201) and the target on the display device (not shown).

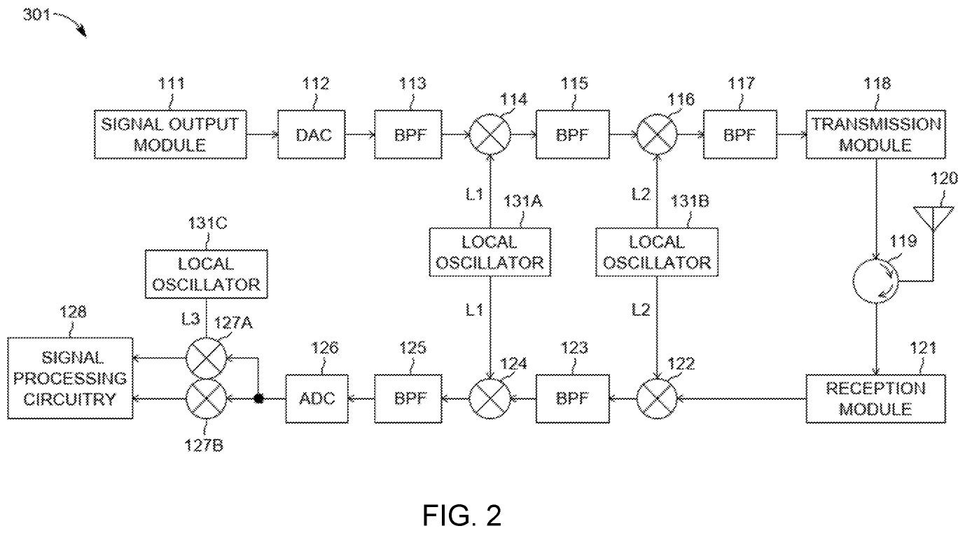

FIG. 2 is a diagram showing the configuration of the radar device, according to a conventional double superheterodyne system. Referring to FIG. 2, a radar device (301) includes a signal output module (111), a DAC (112), a BPF (113), a mixer (114), a BPF (115), a mixer (116), a BPF (117), a transmission module (118), a circulator (119), an antenna (120), a reception module (121), a mixer (122), a BPF (123), a mixer (124), a BPF (125), an ADC (126), mixers (127 A), (127B), a signal processing circuitry (128), and local oscillators (131A), (131B), and (131C). The local oscillators (131A), (131B), and (131C) output local signals L1, L2, and L3 of frequencies f1, f2, and f3, respectively.

For example, at the transmission timing (Tt), the signal output module (111) outputs data representing a sinusoidal waveform with an initial phase of 0 to the DAC (112). The DAC (112) generates an IF signal (Stx) by an analog conversion of the data received from the signal output module (111) and outputs it to the BPF (113).

The mixer (114) generates an up-converted IF signal by multiplying the IF signal (Stx) passed through the BPF (113) and the local signal (L1) received from the local oscillator (131A) and outputs it to the BPF (115). Here, the IF signal generated by the mixer (114) is given a phase rotation (P1) based on the phase of the local signal (L1) at the transmission timing (Tt).

The mixer (116) generates an RF signal by multiplying the IF signal passed through the BPF (115) with the local signal (L2) received from the local oscillator (131B) and outputs it to the BPF (117). The RF signal generated by the mixer (116) is given a phase rotation (P2) based on the phase of the local signal (L2) at the transmission timing (Tt).

The transmission module (118) transmits the RF signal passed through the BPF (117) to the detection target area via the circulator (119) and the antenna (120). The reception module (121) receives the RF signal reflected by the RF signal transmitted by the transmission module (118) via the antenna (120) and the circulator (119), and outputs the received RF signal to the mixer (122).

The mixer (122) generates an IF signal by multiplying the RF signal received from the reception module (121) and the local signal (L2) received from the local oscillator (131B), and outputs it to the BPF (123). That is, in the radar device (301), a local signal used for the up-conversion of the IF signal and a local signal used for the down conversion of the RF signal are shared. Here, a phase rotation (Px1) of the local signal (L2) corresponding to the propagation delay time of the RF signal in the detection target area is applied to the IF signal generated by the mixer (122), while the phase rotation (P2) is removed from the IF signal.

By multiplying the IF signal passed through the BPF (123) with the local signal (L1) received from the local oscillator (131A), the mixer (124) generates a down-converted IF signal and outputs it to the BPF (125). That is, in the radar device (301), the local signal used for up-conversion of the IF signal and the local signal used for down-conversion of the IF signal are shared. Here, a phase rotation (Px2) of the local signal (L1) corresponding to the propagation delay time of the RF signal in the detection target area is applied to the IF signal generated by the mixer (124), while the phase rotation (P1) is removed from the IF signal.

The ADC (126) generates a digital signal by digitally converting the IF signal passed through the BPF (125) and outputs it to the mixers (127A) and (127B). The mixer (127A) generates a digital signal in the baseband band by multiplying the digital signal received from the ADC (126) with the local signal (L3) received from the local oscillator (131C) and outputs it to the signal processing circuitry (128). The mixer (127B) also generates a digital signal in the baseband band by multiplying the digital signal received from the ADC (126) with the local signal L3_90 which is the local signal (L3) emitted from the local oscillator (131C) and to which a phase difference of 90° is applied by the phase shifter (not shown) and outputs it to the signal processing circuitry (128).

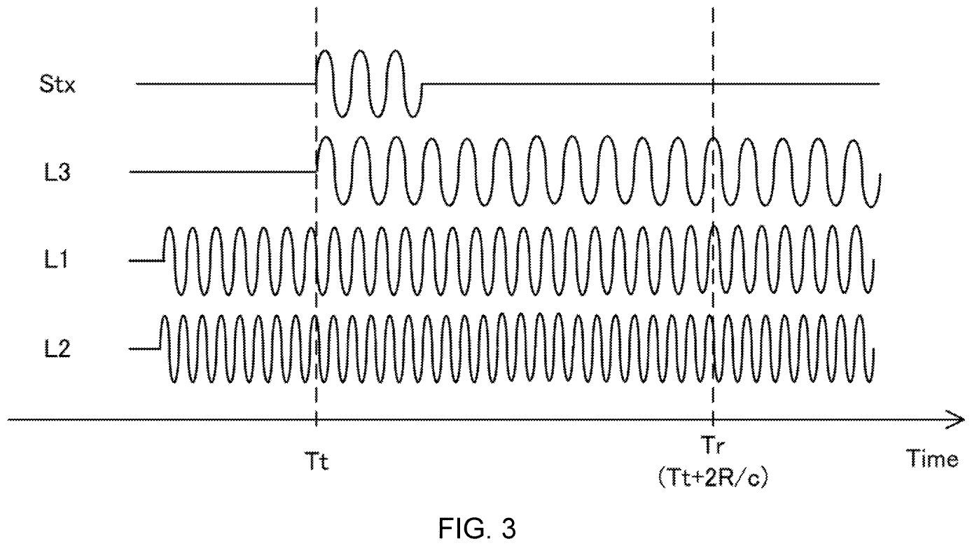

FIG. 3 is a diagram showing a timing chart of a local signal used in the radar device, according to the conventional double superheterodyne system. In FIG. 3, the horizontal axis is time.

Referring to FIG. 3, the local signals (L1) and (L2) output by the local oscillators (131A) and (131B) are free-run signals. On the other hand, the local signal (L3) outputs by the local oscillator (131C) is reset at the transmission timing (Tt). More specifically, the local signal (L3) is controlled so that the initial phase at the transmission timing (Tt) becomes 0. Thus, it is possible to suppress that the demodulated signals generated by the mixers (127A) and (127B) contain unnecessary component resulting from the multiplication of signals in the mixer (114), (116), (122), and (124).

While the double super heterodyne system is a robust system, the radar device (301) that follows the double super heterodyne system may have a large circuit scale and a large number of component. Therefore, a direct conversion system is currently adopted which may be realized by the simple configuration, instead of the double super heterodyne system in marine radar equipment.

However, referring again to FIG. 1, when demodulation signals (SI) and (SQ) are generated by using the local signals (Lc) reset at the transmission timing (Tt) in the digital signal processor module (70) of the radar device (201) according to the direct conversion system, in the same manner as the local signals (L3) in the radar device (301), it may not be possible to detect the speed and movement direction of the object in the detection target area based on the demodulation signals (SI) and (SQ).

More specifically, the signal processing circuitry (73) in the digital signal processor module (70) receives the digital signal (SdI) generated by using the local signals (Lc) reset at the transmission timing (Tt) from the mixer (71A), and extracts the frequency component of the difference between the frequency of the IF signal (Sif) and the frequency (fc) among the frequency component of the received digital signal (SdI) as the demodulation signal (SI). The demodulation signal (SI) extracted by the signal processing circuitry (73) is represented by the following equation (7).

$$\begin{matrix}MATH 07 & \\ SI = cos \{ ( ω a - ω c - ω b ) t + ( ω a - ω b ) Tt - ( ω b + ω c ) \frac{2 R}{c} \} & ( 7 )\end{matrix}$$

Here, since the angular frequency (ωc) is equal to the difference between the angular frequency (ωa) and the angular frequency (ωb), the term at time (t) becomes 0. The term 2×R/c indicates a component of a phase rotation (Pd) corresponding to the propagation delay time of the RF signal (Srf) in the detection target area, and is a necessary term in the detection process. On the other hand, the term of the transmission timing (Tt) indicates component of a phase rotation (Pt) based on the frequency difference between the transmission timing (Tt) and the local signals (La) and (Lb), and is a unnecessary term in the detection process. The demodulation signal (SQ) includes the term of the transmission timing (Tt) as well as the demodulation signal (SI). In this case, the signal processing circuitry (73) may not detect the speed of the target or the movement direction of the target based on the demodulation signals (SI) and (SQ).

Therefore, the radar device (201), according to the embodiment of the present invention, solves the above-mentioned problems by the following configuration.

Based on the digital signal (Sd) generated by the ADC (60), the digital signal processor module (70) generates a baseband signal SBB_ca1, which is the baseband signal SBB having the cancelled component of the phase rotation (Pt) based on the frequency difference of the local signals (La) and (Lb).

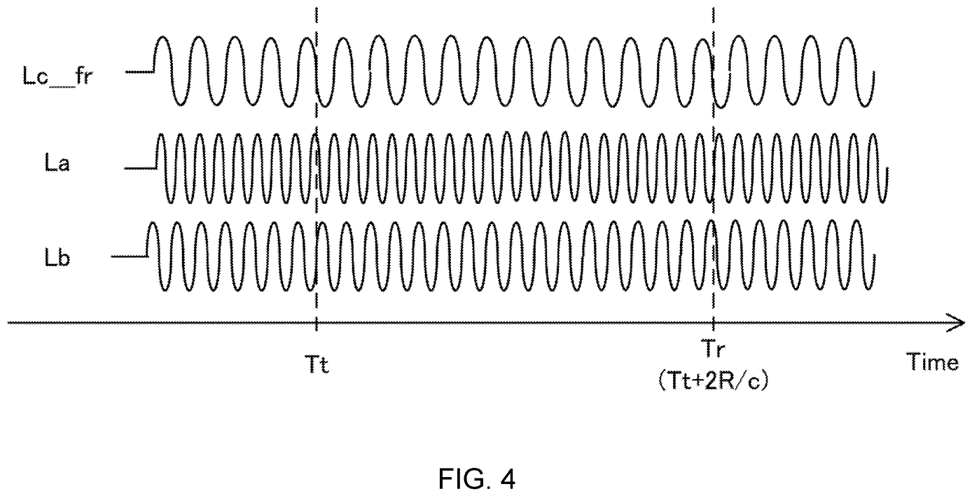

FIG. 4 is a diagram showing a timing chart of the local signal used in the frequency conversion device, according to the first embodiment of the present invention. In FIG. 4, the horizontal axis is time.

Referring to FIG. 4, the local oscillator (72) in the digital signal processor (70) outputs the local signal Lc_fr, which is the local signal (Lc), to the mixer (71). The local signal Lc_fr is a free-run signal. That is, the local signal Lc_fr is a local signal (Lc) that is not reset at the transmission timing (Tt).

By multiplying the digital signal (Sd) received from the ADC (60) and the local signal Lc_fr received from the local oscillator (72), the mixer (71A) generates a digital signal SdI_fr that is a digital signal (SdI) and outputs it to the signal processing circuitry (73). The mixer (71B) also generates a digital signal SdQ_fr that is a digital signal (SdQ) and outputs it to the signal processing circuitry (73) by multiplying the digital signal (Sd) received from the ADC (60) and the local signal Lc_fr_90 that is a local signal Lc_fr that is output from the local oscillator (72) and has been given a phase difference of 90° by a phase shifter (not shown).

The signal processing circuitry (73) receives the digital signal SdI_fr from the mixer (71A) and extracts the frequency component of the difference between the frequency of the IF signal (Sif) and the frequency (fc) among the frequency component of the received digital signal SdI_fr as the demodulated signal SI_fr. The signal processing circuitry (73) receives the digital signal SdQ_fr from the mixer (71B) and extracts the frequency component of the difference between the frequency of the IF signal (Sif) and
the frequency (fc) among the frequency component of the received digital signal SdQ_fr as the demodulated signal SQ_fr. The demodulated signal SI_fr extracted by the signal processing circuitry (73) is represented by the following equation (8).

$$\begin{matrix}MATH 08 & \\ SI\_fr = cos \{ ( ω a - ω c - ω b ) ( t + Tt ) - ( ω b + ω c ) \frac{2 R}{c} \} & ( 8 )\end{matrix}$$

Here, since the angular frequency (ωc) is equal to the difference between the angular frequency (ωa) and the angular frequency (ωb), the terms of the time (t) and the transmission timing (Tt) become 0. Therefore, the demodulated signal SI_fr extracted by the signal processing circuitry (73) is represented by the following equation (9).

$$\begin{matrix}MATH 09 & \\ SI\_fr = cos \{ ( ω b + ω c ) \frac{2 R}{c} \} & ( 9 )\end{matrix}$$

In other words, the demodulated signal SI_fr is a demodulated signal (SI) having a cancelled component of the phase rotation (Pt), not including the term of the transmission timing (Tt). On the other hand, the demodulated signal SI_fr includes the term of 2×R/c required in the detection processing.

The demodulated signal SQ_fr extracted by the signal processing circuitry (73) is represented by the following equation (10).

$$\begin{matrix}MATH 10 & \\ SQ\_fr = sin \{ ( ω b + ω c ) \frac{2 R}{c} \} & ( 10 )\end{matrix}$$

In other words, the demodulated signal SQ_ft, like the demodulated signal SI_fr, is a demodulated signal SQ having both a cancelled component of the phase rotation Pt and the term 2×R/c.

The signal processing circuitry (73) detects the speed and the movement direction of the object based on the baseband signal SBB_ca1 having a cancelled component of the phase rotation (Pt) being described as the following equation (11).

$$\begin{matrix}MATH 11 & \\ SBB\_ca 1 = cos \{ ( ω b + ω c ) \frac{2 R}{c} \} + j sin \{ ( ω b + ω c ) \frac{2 R}{c} \} & ( 11 )\end{matrix}$$

The radar device (201), according to the embodiment of the present invention, is provided with a computer including a memory and a processor such as a CPU in the computer reads and executes a program including a part or all of the steps in the following flowchart from the memory. The program of the radar device (201) may be installed externally. The program of the radar device (201) is distributed in a state stored in a recording medium or through a communication line.

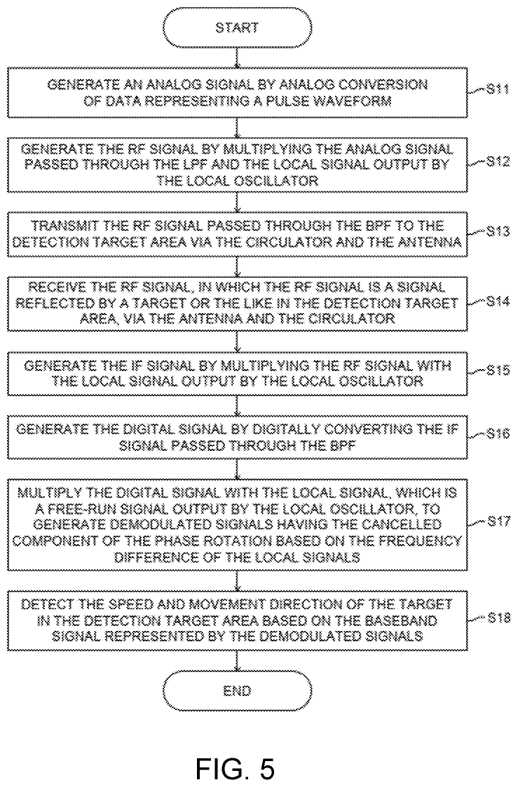

FIG. 5 is a flowchart showing an example of an operation when the radar device (201) performs detection process, according to the first embodiment of the present invention. The radar device (201) executes the processing shown in FIG. 5 for each transmission timing (Tt), according to the transmission period (Tprf).

Referring to FIG. 5, the radar device (201) first generates an analog signal (Sa) by analog conversion of data (Da) representing a pulse waveform (step S11).

Further, the radar device (201) generates the RF signal (Srf1) by multiplying the analog signal (Sa) passed through the LPF (31) and the local signal (La) outputs by the local oscillator (33) (step S12).

Further, the radar device (201) transmits the RF signal (Srf1) passed through the BPF (34) to the detection target area via the circulator (42) and the antenna (43) (step S13).

Further, the radar device (201) receives the RF signal (Srf2), in which the RF signal (Srf1) is a signal reflected by a target or the like in the detection target area, via the antenna (43) and the circulator (42) (step S14).

Further, the radar device (201) generates the IF signal (Sif) by multiplying the RF signal (Srf2) with the local signal (Lb) outputs by the local oscillator (52) (step S15).

Further, the radar device (201) generates the digital signal (Sd) by digitally converting the IF signal (Sif) passed through the BPF (53) (step S16).

Further, the radar device (201) multiplies the digital signal (Sd) with the local signal Lb_fr, which is a free-run signal output by the local oscillator (52), to generate demodulated signals SI_fr and SQ_fr having cancelled component of the phase rotation (Pt) based on the frequency difference of the local signals (La) and (Lb) (step S17).

Further, the radar device (201) detects the speed and movement direction of the target in the detection target area based on the baseband signal SBB_ca1 represented by the demodulated signals SI_ft and SQ_fr (step S18).

Further, another embodiment of the present invention will be described with reference to the drawings. The same reference numerals are used for the same or equivalent portions in the drawings, and the description is not repeated.

Second Embodiment—Configuration and basic operation—This embodiment relates to a radar device (202) which performs a process of subtracting component of phase rotation (Pt) compared with the radar device (201) according to the first embodiment. The radar device (201), according to the first embodiment, is the same except for the contents described below.

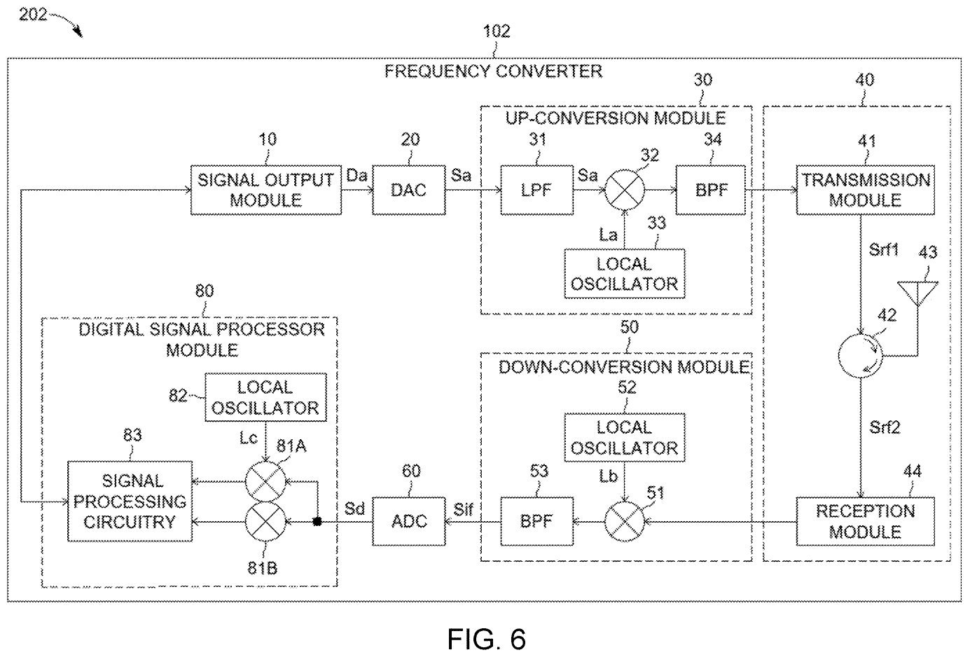

FIG. 6 is a diagram showing a configuration of the radar device (202), according to a second embodiment of the present invention. Referring to FIG. 2, the radar device (201) includes a frequency converter (102) instead of the frequency converter (101) compared with the radar device (202). The frequency converter (102) includes a digital signal processor module (80) instead of the digital signal processor module (70). Compared with the digital signal processor module (70), the digital signal processor module (80) includes mixers (81A) and (81B) which are mixers (81) instead of the mixer (71), a local oscillator (82) instead of the local oscillator (72), and a signal processing circuitry (83) instead of the signal processing circuitry (73). The digital processor module (80) is an example of the cancellation module.

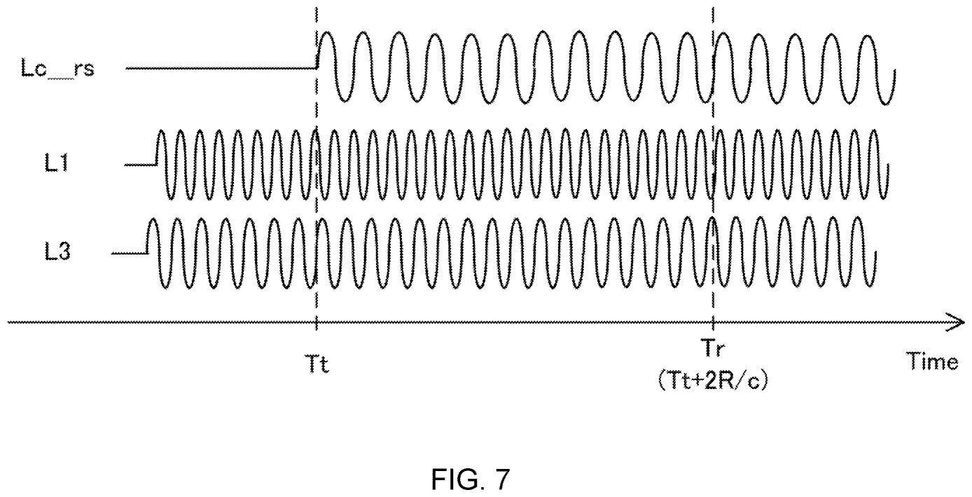

FIG. 7 is a diagram showing a timing chart of a local signal used in the frequency converter (102), according to the second embodiment of the present invention. In FIG. 7, the horizontal axis is time.

Referring to FIG. 7, the local oscillator (82) in the digital signal processor module (80) outputs the local signal Lc_rs, which is the local signal Lc, to the mixer (81). The local signal Lc_rs is the local signal (Lc) that is reset at the transmission timing (Tt). More specifically, the local signal Lc_rs is controlled so that the initial phase at the transmission timing (Tt) is zero. Thus, generation of unnecessary component in the baseband signal (SBB) caused by up-conversion in the up-conversion module (30) and down-conversion in the down-conversion module (50) may be suppressed.

The digital signal processor module (80) subtracts the component of the phase rotation (Pt) calculated on the basis of the frequency difference between the local signals (La) and (Lb) and the transmission period (Tprf) of the RF signal (Srf1) from the baseband signal (SBB) obtained by multiplying the digital signal (Sd) and the local signal Lc_rs, thereby generating the baseband signal SBB_ca2 having a cancelled component of the phase rotation (Pt) are cancelled.

More specifically, the mixer (81A) multiplies the digital signal (Sd) received from the ADC (60) and the local signal Lc_rs received from the local oscillator (82), thereby generating the digital signal SdI_rs which is the digital signal (SdI) and outputting it to the signal processing circuitry (83). Further, the mixer (81B) multiplies the digital signal (Sd) received from the ADC (60) and the local signal Lc_rs_90 which is the local signal Lc_rs outputted from the local oscillator (82) and given a phase difference of 90° by a phase shifter (not shown), thereby generating the digital signal SdQ_rs which is the digital signal (SdQ) and outputting it to the signal processing circuitry (83).

The signal processing circuitry (83) receives the digital signal SdI_rs from the mixer (81A) and extracts the frequency component of the difference between the frequency of the IF signal (Sif) and the frequency (fc) among the frequency component of the received digital signal SdI_rs as the demodulated signal SI_rs. The signal processing circuitry (83) receives the digital signal SdQ_rs from the mixer (81B) and extracts the frequency component of the difference between the frequency of the IF signal (Sif) and the frequency (fc) among the frequency component of the received digital signal SdQ_rs as the demodulated signal SQ_rs.

The signal processing circuitry (83) monitors the data (Da) outputted by the signal output module (10) and counts the number (n) of transmissions of the RF signal (Srf1) by the radar device (301). More specifically, the signal processing circuitry (83) counts the number of times the pulse signal represented by the data (Da) transitions from a low level to a high level as the number (n) of transmissions. Hereinafter, the nth transmission timing (Tt) is also referred to as the “transmission timing Ttn”. The demodulation signal SI_rs corresponding to the RF signal (Srf2) to which the RF signal (Srf1) transmitted at the transmission timing (Ttn) is reflected is also referred to as the “demodulation signal SI_rsn”. The demodulated signal SQ_rs corresponding to the RF signal (Srf2) to which the RF signal (Srf1) transmitted at the transmission timing (Ttn) is reflected is also referred to as the “demodulated signal SQ_rsn”. The demodulated signal SI_rsn is represented by the following equation (12).

$$\begin{matrix}MATH 12 & \\ SI\_rsn = cos \{ ( ω a - ω b ) Tt 1 + ( ω a - ω b ) nTprf - ( ω b + ω c ) \frac{2 R}{c} \} & ( 12 )\end{matrix}$$

The signal processing circuitry (83) performs calculation processing to subtract the value corresponding to the term of the transmission period (Tprf) from the demodulated signal SI_rsn based on the known angular frequencies ωa, ωb, the transmission period (Tprf), and the counted transmission number (n). The demodulated signal SI_rsn after calculation processing is represented by the following equation (13).

$$\begin{matrix}MATH 13 & \\ SI\_rsn = cos \{ ( ω a - ω b ) Tt 1 - ( ω b + ω c ) \frac{2 R}{c} \} & ( 13 )\end{matrix}$$

In the same manner, the signal processing circuitry (83) performs calculation processing to subtract the value corresponding to the term of the transmission period (Tprf) from the demodulated signal SQ_rsn. The demodulated signal SQ_rsn after calculation processing is represented by the following equation (14).

$$\begin{matrix}MATH 14 & \\ SQ\_rsn = sin \{ ( ω a - ω b ) Tt 1 - ( ω b + ω c ) \frac{2 R}{c} \} & ( 14 )\end{matrix}$$

Here, the demodulated signals SI_rsn and SQ_rsn after calculation processing include the term of the transmission timing (Tt1). The term of the transmission timing (Tt1) is a component of the phase rotation (Pt), but since it has a fixed value C, it may be ignored in the processing for detecting the speed and movement direction of the object. Even when the transmission period (Tprf) is not a fixed value but a variable value, the signal processing circuitry (83) may subtract the value corresponding to the term of the transmission period (Tprf) from the demodulated signals SI_rsn and SQ_rsn based on the monitoring result of the data (Da) output by the signal output module (10).

The signal processing circuitry (83) detects the speed and the movement direction of the object based on the baseband signal SBB_ca2 in which the component of the phase rotation (Pt) except for the fixed value C are cancelled, which is represented by the following equation (15).

$$\begin{matrix}MATH 15 & \\ SBB\_ca 2 = cos \{ C - ( ω b + ω c ) \frac{2 R}{c} \} + j sin \{ C - ( ω b + ω c ) \frac{2 R}{c} \} & ( 15 )\end{matrix}$$

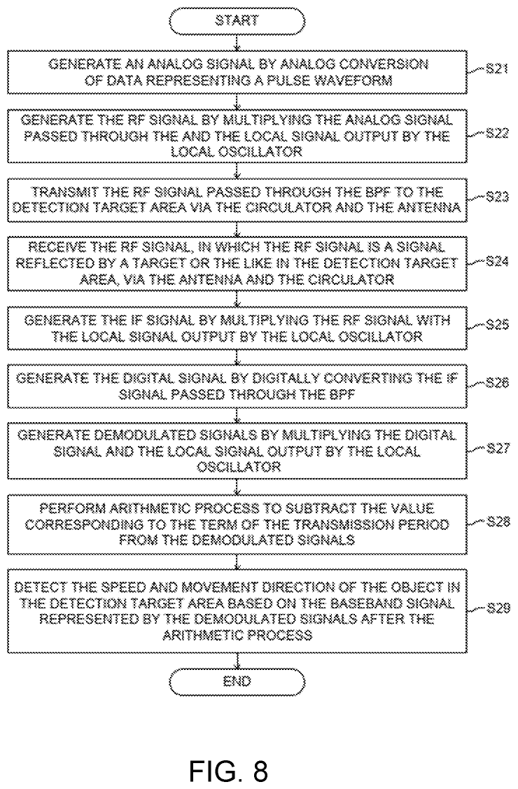

FIG. 8 is a flowchart showing an example of an operation in which the radar device (202) performs detection process, according to the second embodiment of the present invention. The radar device (202) executes the processing shown in FIG. 8 for each transmission timing (Tt) according to the transmission period (Tprf).

Referring to FIG. 8, the radar device (202) executes the same processing as the processing of the steps S11 to S16 in FIG. 5 as the processing of the steps S21 to S26.

Further, the radar device (202) generates demodulated signals SI_rsn and SQ_rsn by multiplying the digital signal (Sd) and the local signal Lc_rs output by the local oscillator (52) (step S27).

Further, the radar device (202) performs arithmetic process to subtract the value corresponding to the term of the transmission period (Tprf) from the demodulated signals SI_rsn and SQ_rsn (step S28).

Further, the radar device (202) detects the speed and movement direction of the object in the detection target area based on the baseband signal SBB_ca2 represented by the demodulated signals SI_rsn and SQ_rsn after the arithmetic process (step S29).

It should be considered that the above embodiment is exemplary in all respects and not restrictive. It is intended that the scope of the present invention be indicated by the claims rather than the above description and include all changes within the meaning and scope of the claims and equivalence. It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of nontransitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be considered that the above embodiment is exemplary in all respects and not restrictive. It is intended that the scope of the present invention be indicated by the claims rather than the above description and include all changes within the meaning and scope of the claims and equivalence.

It should be emphasized that many variations and modifications may be made to the above-described embodiments, the elements of which are to be understood as being among other acceptable examples. All such modifications and variations are intended to be included herein within the scope of this disclosure and protected by the following claims.

### REFERENCE CHARACTERS LIST

10 Signal output module
20 Digital to analog convertor (DAC)
30 Up-conversion module
31 Low Pass Filter (LPF)
32 Mixer
33 Local oscillator
34 Band Pass Filter (BPF)
40 Transmitter/reception module
41 Transmission module
42 Circulator
43 Antenna
44 Reception module
50 Down-conversion module
51 Mixer
52 Local oscillator
53 BPF
60 Analog to digital convertor (ADC)
70 Digital signal processor module
71 Mixer
71A and 71B Mixer
72 Local oscillator
73 Signal processing circuitry
80 Digital signal processor module
81 Mixer
81A and 81B Mixer
82 Local oscillator
83 Signal processing circuitry
101 Frequency converter
102 Frequency converter
111 Signal output module
112 DAC
113 BPF
114 Mixer
115 BPF
116 Mixer
117 BPF
118 Transmission module
119 Circulator
120 Antenna
121 Reception module
122 Mixer
123 BPF
124 Mixer
125 BPF
126 ADC
127A and 127B Mixer
128 Signal processing circuitry
131A, 131B, and 131C Local oscillator
201, 202, and 301 Radar Device

1. A frequency conversion device comprising:
a digital-to-analog converter configured to generate an analog signal by analog conversion of data representing a pulse-like waveform;
an up-converter configured to generate an RF (radio frequency) signal by multiplying the analog signal with a first local signal;
a transmitter configured to transmit the RF signal;
a receiver configured to receive a reflected signal of the RF signal;
a down-converter configured to generate an IF (intermediate frequency) signal by multiplying the reflected signal with a second local signal having a different frequency from the first local signal;
an analog-to-digital converter configured to generate a digital signal by digitally converting the IF signal; and
processing circuitry configured to generate a baseband signal having a cancelled phase rotation component based on the frequency difference between the first local signal and the second local signal based on the digital signal.

2. The frequency conversion device of claim 1, wherein
the processing circuitry is further configured to generate the baseband signal by multiplying the digital signal with a third local signal of a frequency based on the frequency difference, wherein
the third local signal is a free-run signal.

3. The frequency conversion device of claim 1, wherein
the processing circuitry is further configured to generate the baseband signal by subtracting component of the phase rotation calculated based on the frequency difference and the transmission period of the RF signal from a signal obtained by multiplying the digital signal with the third local signal of a frequency based on the frequency difference.

4. A radar device comprising:
the frequency conversion device of any one of claim 1.

5. A frequency conversion method comprising:
generating, by a digital-to-analog converter, an analog signal by analog conversion of data representing a pulse-like waveform;
generating, by an up-converter, an RF (radio frequency) signal by multiplying the analog signal with a first local signal;
transmitting, by a transmitter, the RF signal;
receiving, by a receiver, a reflected signal of the RF signal;
generating, by a down-converter, an IF (intermediate frequency) signal by multiplying the reflected signal with a second local signal having a different frequency from the first local signal;
generating, by an analog-to-digital converter, a digital signal by digitally converting an IF signal; and
generating, by processing circuitry, a baseband signal having a cancelled phase rotation component based on the frequency difference between the first local signal and the second local signal based on the digital signal.

6. A non-transitory computer-readable medium storing instructions that, when executed by processing circuitry, cause the processing circuitry to perform operations comprising:
generating, by a digital-to-analog converter, an analog signal by analog conversion of data representing a pulse-like waveform;
generating, by an up-converter, an RF (radio frequency) signal by multiplying the analog signal with a first local signal;
transmitting, by a transmitter, the RF signal;
receiving, by a receiver, a reflected signal of the RF signal;
generating, by a down-converter, an IF (intermediate frequency) signal by multiplying the reflected signal with a second local signal having a different frequency from the first local signal;
generating, by an analog-to-digital converter, a digital signal by digitally converting an IF signal; and
generating, by processing circuitry, a baseband signal having a cancelled phase rotation component based on the frequency difference between the first local signal and the second local signal based on the digital signal.
